(19) United States
(12) Patent Application Publication
(10) Pub. No.: US 2019/0346292 A1
(43) Pub. Date: Nov. 14, 2019

(54) MAGNETIC ENCODER, AND METHOD AND DEVICE FOR PRODUCING SAME

(71) Applicant: NTN CORPORATION, Osaka (JP)

(72) Inventors: Takashi KOIKE, Iwata (JP); Yasuyuki FUKUSHIMA, Iwata (JP); Yuya YAMAGUCHI, Iwata (JP)

(73) Assignee: NTN CORPORATION, Osaka (JP)

(21) Appl. No.: 16/521,116

(22) Filed: Jul. 24, 2019

Related U.S. Application Data
(63) Continuation of application No. PCT/JP2018/002827, filed on Jan. 30, 2018.

(30) Foreign Application Priority Data
Feb. 2, 2017 (JP) 2017-017303

(51) Int. Cl. G01D 5/245; G01D 5/244; G01D 5/14

(52) U.S. Cl. CPC G01D 5/2452; G01D 5/14; G01D 5/24438

(57) ABSTRACT

Provided is a magnetic encoder that can be produced by a simple modification of an existing production method and that can detect an absolute angle with high efficiency, and a method and an apparatus for producing the magnetic encoder. In a magnetic encoder, a plurality of rows of magnetic tracks, each having N poles and S poles arranged alternately, are disposed adjacent to each other. The rows of magnetic tracks include a main track used for calculating an angle and a sub track used for calculating a phase difference from the main track. The number of magnetic poles of the main track is larger than that of the sub track. The main track is magnetized after the sub track. Thus, accuracy of pitch of the magnetic poles is higher in the main track than in the sub track.

### CROSS REFERENCE TO THE RELATED APPLICATION

This application is a continuation application, under 35 U.S.C. § 111(a), of international application No. PCT/JP2018/002827, filed Jan. 30, 2018, which is based on and claims Convention priority to Japanese patent application No. 2017-017303, filed Feb. 2, 2017, the entire disclosure of which is herein incorporated by reference as a part of this application.

### BACKGROUND OF THE INVENTION

### Field of the Invention

The present invention relates to a magnetic encoder used for detecting a rotation speed or a rotation position, and a method and an apparatus for producing the magnetic encoder. In particular, the present invention relates to a technology applicable to: a magnetic encoder having a plurality of rows of magnetic encoder tracks or magnetic tracks that are used for detecting an absolute angle; and a method and an apparatus for producing the magnetic encoder.

### Description of Related Art

A magnetic encoder device disclosed in Patent Document 1 is obtained as follows. A base portion is formed of a sintered metal and is inserted in a mold and subjected to injection molding by use of a resin material containing a thermoplastic resin and a magnetic powder as main components, to obtain a molded portion. On the molded portion, a magnetic encoder track having a plurality of magnetic poles is formed in the circumferential direction of the molded portion. The magnetic encoder track is arranged in a plurality of circular rows, and an absolute angle of a rotary shaft is detected based on a phase difference between magnetic signals detected in the different tracks.

Patent Document 2 proposes a magnetic encoder in which, when magnetization of a plurality of rows of magnetic encoder tracks is performed, flow of a magnetic flux to the rows of tracks other than a magnetization target row is shielded by use of a magnetic shield.

### Related Document

### Patent Document

[Patent Document 1] JP Laid-open Patent Publication No. 2015-075466

[Patent Document 2] Japanese Patent No. 5973278

### SUMMARY OF THE INVENTION

Patent Document 1 provides a magnetic encoder in which double rows of magnetic encoder tracks are arranged, and each track is magnetized with a predetermined number of pole pairs such that a difference of one pole pair is provided between the tracks. For example, in a magnetic encoder in which one magnetic encoder track is magnetized with 32 pole pairs while the other magnetic encoder track is magnetized with 31 pole pairs, an absolute angle of a rotary shaft is detected by utilizing the fact that a difference of one pole pair per rotation is generated.

However, this magnetic encoder that detects an absolute angle by utilizing a difference of one pole pair per rotation is required to have higher magnetization accuracy. For example, in a case where an absolute angle is detected by using two rows of magnetic encoder tracks respectively magnetized with 32 pole pairs and 31 pole pairs, an angle per pole pair, on the 32-pole-pairs side, is 11.25° (360/32). In order to determine the present phase position, a magnetization accuracy of not more than 0.35° (11.25/32), or, for the sake of safety, a magnetization accuracy within ±0.1°, is required. If the number of magnetic poles is increased to be, for example, 64 pole pairs and 63 pole pairs, the required accuracy becomes stricter. For example, a magnetization accuracy within ±0.04° is required.

Patent Document 2 discloses a magnetization device using a magnetizing yoke. In this magnetization device, when magnetization of a plurality of rows of magnetic encoder tracks is performed, in order to prevent an adjacent magnetic encoder track from being affected, a magnetic encoder track, which is not to be magnetized, is shielded by a magnetic shield member of the magnetizing yoke. However, Patent Document 2 does not describe in what order the magnetic encoder tracks should be magnetized nor which magnetic encoder track should have higher accuracy.

Therefore, an object of the present invention is to provide: a magnetic encoder that can be produced by simple modification of an existing production method and that can detect an absolute angle with high accuracy; and a method and an apparatus for producing the magnetic encoder.

A magnetic encoder according to the present invention includes a plurality of rows of magnetic tracks disposed adjacent to each other. Each track has N poles and S poles arranged alternately. The plurality of rows of magnetic tracks include a main track used for calculating an angle and a sub track used for calculating a phase difference from the main track. The number of magnetic poles of the main track is larger than the number of magnetic poles of the sub track. The accuracy of pitch of the magnetic poles is higher in the main track than in the sub track. For example, the number of magnetic poles of the main track is larger by one than the number of magnetic poles of the sub track.

Generally, as for a magnetic encoder, an un-magnetized magnetic encoder is produced in advance, and thereafter, magnetization is performed on the un-magnetized magnetic encoder. In this case, a plurality of magnetic tracks are sequentially magnetized. A magnetic track that has been magnetized first is assumed to be reduced in accuracy due to leakage of a magnetic flux when a subsequent magnetic track is magnetized. Therefore, it is difficult to magnetize, with high accuracy, all the magnetic tracks arranged adjacent to each other. Therefore, in the magnetic encoder of the present invention, a magnetic track, whose accuracy of pitch of magnetic poles is reduced, is regarded as a sub track. Since the sub track is a magnetic track used for calculating a phase difference from the main track, influence of the accuracy of the magnetization pitch thereof is relatively small. Therefore, if the accuracy of the magnetization pitch of the main track, which has the larger number of magnetic poles and is used for calculating an angle, is made higher than that of the sub track, the magnetic encoder is rendered to be able to detect an absolute angle with high accuracy within a limited range of accuracy in production.

Furthermore, the magnetic encoder of the present invention can be produced by a simple modification of the existing production method, for example, by simply adjusting the order of magnetization of the respective magnetic tracks, as mentioned above, such that the accuracy of pitch of magnetic poles is higher in the main track than in the sub track. It is noted that the magnetic encoder of the present invention is applicable not only to a magnetic encoder in which magnetizations for the respective magnetic tracks are successively performed but also to general magnetic encoders in which a difference in accuracy occurs between magnetic tracks.

In the magnetic encoder of the present invention, the plurality of rows of magnetic tracks may be annularly arrayed. In each row of magnetic tracks, the magnetic poles may face the outer peripheral side or the inner peripheral side of the annulus, or may face in the axial direction. The present invention is effectively applied to such a magnetic encoder. It is noted that the magnetic encoder of the present invention may have linearly extending magnetic tracks.

A magnetic encoder production method according to the present invention is a method for producing a magnetic encoder including a plurality of rows of magnetic tracks disposed adjacent to each other, in which each track has N poles and S poles arranged alternately, the plurality of rows of magnetic tracks include a main track used for calculating an angle and a sub track used for calculating a phase difference from the main track, and the number of magnetic poles of the main track is larger than the number of magnetic poles of the sub track. After the magnetic encoder, which has not been magnetized, is produced, the respective magnetic tracks of such un-magnetized magnetic encoder are individually magnetized in a sequential order such that the main track is magnetized after the sub track, whereby accuracy of pitch of the magnetic poles is made higher in the main track than in the sub track.

According to this production method, when a magnetic encoder is produced by magnetizing an un-magnetized magnetic encoder in a plurality of rows (e.g., two rows) of tracks having different numbers of magnetic pole pairs, a magnetic track (sub track) that has the less number of magnetic pole pairs and is used for detecting a phase position is magnetized first, and a magnetic track (main track) that has the larger number of magnetic pole pairs and is used for calculating an angle is magnetized last.

In the case where the magnetic track (main track) having the larger number of magnetic pole pairs that affect the angular accuracy is magnetized first, when the other magnetic track (sub track) is magnetized thereafter, leakage of a magnetic flux may cause reduction in accuracy of the main track, as described above. However, in the present invention, since the main track having the larger number of magnetic pole pairs that affect the angular accuracy is magnetized last, reduction in accuracy of the main track is inhibited, whereby an absolute angle can be detected with high accuracy. Moreover, the magnetic encoder can be produced by a simple modification of the existing production method, that is, by simply adjusting the order of magnetization of the respective magnetic tracks as this invention described above.

In the magnetic encoder production method according to the present invention, when magnetization of the respective magnetic tracks is performed, the N poles and the S poles may be alternately magnetized one by one while shielding, with a magnetic shield, a portion corresponding to a magnetic track that is not currently being magnetized. As described above, since the N poles and the S poles are alternately magnetized one by one while shielding, with the magnetic shield, the portion corresponding to the magnetic track that is not currently being magnetized, influence of leakage of a magnetic flux is minimized, whereby magnetization with relatively high accuracy can be performed. Even in the above method, strictly speaking, influence on the accuracy of the already magnetized magnetic track may be unavoidable in some cases. In the present invention, however, since the main track is magnetized later, reduction in accuracy of the main track is inhibited, and an absolute angle can be detected with high accuracy.

A magnetic encoder production apparatus according to the present invention is an apparatus for producing a magnetic encoder including a plurality of rows of magnetic tracks disposed adjacent to each other, in which each track has N poles and S poles arranged alternately, the plurality of rows of magnetic tracks include a main track used for calculating an angle and a sub track used for calculating a phase difference from the main track, and the number of magnetic poles of the main track is larger than the number of magnetic poles of the sub track. The apparatus includes: a magnetizing yoke configured to magnetize the magnetic tracks of the magnetic encoder that has not been magnetized, the magnetizing yoke having end portions opposing the magnetic tracks; an exciting coil that is wound around the magnetizing yoke; a magnetization power source configured to supply a magnetization current to the exciting coil to cause a magnetic flux to pass between the opposing end portions; a positioning device configured to position the magnetizing yoke relative to such un-magnetized magnetic encoder; and a controller configured to control the magnetization power source and the positioning device. The controller controls the magnetization power source and the positioning device so as to individually magnetize the respective magnetic tracks of the un-magnetized magnetic encoder in a sequential order such that the main track is magnetized after the sub track, whereby accuracy of pitch of the magnetic poles is made higher in the main track than in the sub track.

The magnetic encoder production apparatus having the above configuration can implement the production method according to the present invention. Therefore, degradation in accuracy of the main track is inhibited, and an absolute angle can be detected with high accuracy. With the production apparatus of the present invention, the above-described magnetic encoder can be produced by a simple modification of the existing production method, that is, by simply adjusting the order of magnetization of the respective magnetic tracks, as described above for the production method.

In the magnetic encoder production apparatus of the present invention, the magnetizing yoke may be provided with a magnetic shield that shields a flow of a magnetic flux to a magnetic encoder track in a row other than a magnetization target. The magnetic shield allows magnetization with higher accuracy. Even with the magnetic shield, strictly speaking, as mentioned above, influence on the accuracy of the already magnetized magnetic track may be unavoidable in some cases. In the present invention, however, since the main track is magnetized last, degradation in accuracy of the main track is inhibited, and an absolute angle can be detected with high accuracy. With the production apparatus of the present invention, the above-described magnetic encoder can be produced by a simple modification of the existing production method, that is, by simply adjusting the order of magnetization of the respective magnetic tracks as described above.

Any combination of at least two constructions, disclosed in the appended claims and/or the specification and/or the accompanying drawings should be construed as included within the scope of the present invention. In particular, any combination of two or more of the appended claims should be equally construed as included within the scope of the present invention.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a longitudinal-sectional view of a magnetic encoder according to an embodiment of the present invention;

FIG. 2 shows function of the magnetic encoder where chart (a) thereof is a development showing an arrangement of magnetic poles of the magnetic encoder, charts (b) and (c) show waveforms of two signals obtained from two tracks of the magnetic encoder, and chart (d) shows a waveform of a phase difference between the two signals;

FIG. 3 is a longitudinal-sectional view of an example of a production apparatus for producing the magnetic encoder;

FIG. 4 is a cross-sectional view taken along a line IV-IV in FIG. 3 as viewed from above;

FIG. 5 is a longitudinal-sectional view showing magnetization steps of the magnetic encoder by the production apparatus where the step of chart (a) is followed by that of chart (b); and

FIG. 6 shows arrangement of magnetic poles in a plurality of rows in the magnetic encoder.

### DESCRIPTION OF EMBODIMENTS

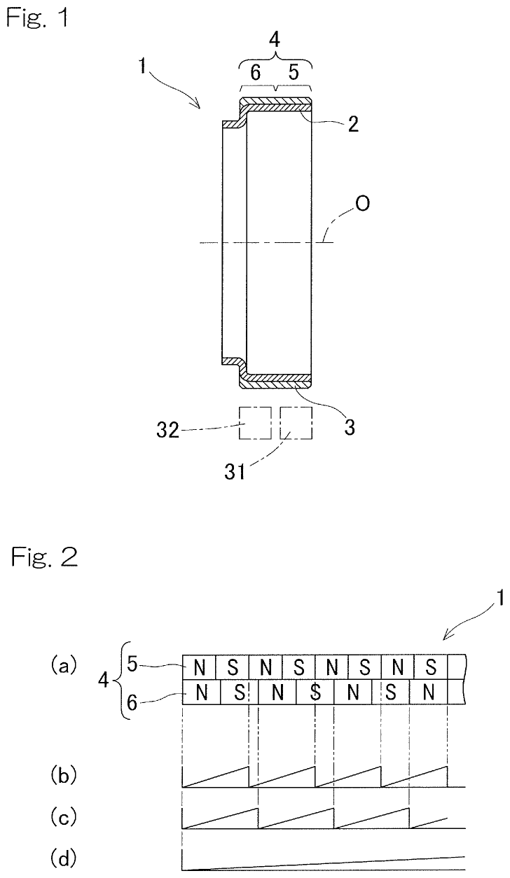

An embodiment of the present invention will be described with reference to the drawings. FIG. 1 is a longitudinal-sectional view of a magnetic encoder. In FIG. 2, chart (a) shows magnetization patterns of magnetic tracks developed in the circumferential direction, charts (b) and (c) show detection signals corresponding to respective magnetic pole pairs in the magnetization patterns, and chart (d) shows a phase difference between the detection signals.

The magnetic encoder 1 is produced as follows. A rubber material, in which a magnetic powder is kneaded, is put in a mold together with a core member 2 which is a metal ring, and is bonded through vulcanization to the outer peripheral surface of the core member 2 to form an annular magnetic member 3. Alternatively, a core member 2 and a mixture of a plastic material and a magnetic powder are integrally molded to form an annular magnetic member 3 on the outer peripheral surface of the core member 2. Then, a plurality of rows (two rows in this embodiment) of magnetic tracks 4 having different numbers of magnetic pole pairs are formed on the surface of the magnetic member 3 that has not been magnetized. As for the plurality of rows of the magnetic tracks 4, for example, one of the rows, serving as a main track 5, is magnetized with 32 pole pairs while the other magnetic track, serving as a sub track 6, is magnetized with 31 pole pairs. In this magnetic encoder 1, the main track 5 is magnetized after the sub track 6 as described below, whereby accuracy of pitch of the magnetic poles is higher in the main track 5 than in the sub track 6. The magnetic encoder 1 is mounted to a rotary member (not shown) such as a rotary shaft or a rotating ring of a wheel bearing, and is used for detection of an absolute angle.

This magnetic encoder is used for detection of an absolute angle of a rotary shaft by utilizing the fact that a difference of one pole pair is generated per rotation. For example, as magnetic sensors for absolute angle detection, magnetic sensors 31 and 32 are disposed so as to oppose the main track 5 and the sub track 6 of the magnetic encoder 1, respectively, and the magnetic encoder 1 is rotated around the center-of-annulus O. In this case, the detection signal shown in chart (b) of FIG. 2 is outputted from the magnetic sensor 31 on the main track 5 side while the detection signal shown in chart (c) of FIG. 2 is outputted from the magnetic sensor 32 on the sub track 6 side. Each detection signal is a signal in which one pair of an N pole and an S pole corresponds to a cycle from 0° to 360° in phase. By taking a difference between these detection signals, as shown in chart (d) of FIG. 2, a phase difference signal that linearly change of waveform is obtained with rotation of the magnetic encoder 1. In this case, with one rotation from 0° to 360° of the magnetic encoder 1, the phase difference signal indicates a waveform of one period.

In detecting an absolute angle, an angle is calculated based on the main track 5, and an absolute angle can be detected while recognizing the position of the main track based on the difference of the phase between the main track 5 and the sub track 6. Since the main track 5 is magnetized with higher accuracy than the sub track 6, detection of the absolute angle in this case can be performed with higher accuracy than that in the case where the sub track 6 is magnetized with higher accuracy than the main track 5. It is noted that an absolute angle detection device is composed of: the magnetic encoder 1; the magnetic sensors 31 and 32; and a software or hardware (not shown) such as an electronic circuit that performs calculation of the absolute angle from the detection signals of the magnetic sensors 31 and 32.

Examples of magnetization methods include: a method of magnetizing the magnetic tracks 4 (5 and 6) in a predetermined order while rotating the magnetic encoder 1, by using an index magnetization device that magnetizes N poles and S poles alternately one by one; and one-shot magnetization in which both the magnetic tracks 4 (5 and 6) are simultaneously magnetized. Either method may be used. However, the one-shot magnetization complicates the structure of the magnetizing yoke and causes magnetic interference between the magnetic tracks 4 (5 and 6) during magnetization, which makes magnetization with high accuracy difficult. Therefore, the magnetization using the index magnetization device is preferred when the magnetic encoder 1 has a plurality of rows of magnetic tracks 4.

For example, in a case where an absolute angle is detected by using two rows of magnetic tracks 4 (5 and 6) that are magnetized with 32 pole pairs and 31 pole pairs, respectively (in this case, the number of the magnetic poles of the main track 5 is larger by one than the number of the magnetic poles of the sub track 6), an angle per pole pair on the 32 pole pairs side (main track 5 side) is 11.25° (360/32). In order to determine the present phase position, a magnetization accuracy of not more than 0.35° corresponding to one 32th of 11.25° (11.25/32), or, for the sake of safety, a magnetization accuracy within ±0.1°, is required. If the number of magnetic poles is increased to be, for example, 64 pole pairs and 63 pole pairs, the required accuracy becomes stricter. For example, a magnetization accuracy within ±0.04° is required.

In a case where the main track 5 having the larger number of magnetic pole pairs to be used for calculation of an angle is magnetized first, when the sub track 6 is magnetized thereafter, leakage of a magnetic flux may affect the accuracy of the main track 5, e.g., a pitch error (pitch accuracy) or an accumulated pitch error (accumulated pitch accuracy). In this case, the angular accuracy is reduced.

Each of the pitch error and the accumulated pitch error is an index indicating the accuracy of the magnetized track. For example, assuming that a magnetic track is magnetized with 32 pole pairs, an angle per pole pair is theoretically 11.25°. Then, if the angle of a certain pole pair is 11.3° in actuality, this pole pair has a pitch error of +0.05°. The accumulated pitch error is obtained by accumulating the pitch errors of all the pole pairs, and is represented by the maximum value (amplitude) thereof.

Therefore, it is preferred to magnetize last the main track 5 having the larger number of magnetic pole pairs that affect the angular accuracy. Thus, degradation in accuracy of the main track 5 is inhibited, and an absolute angle can be detected with high accuracy. In this case, when the main track 5 is magnetized, this magnetization may affect the accuracy of the sub track 6 that has been magnetized first. However, since the sub track 6 is used for recognizing the phase relationship with the main track 5, the accuracy thereof need not be taken into much consideration.

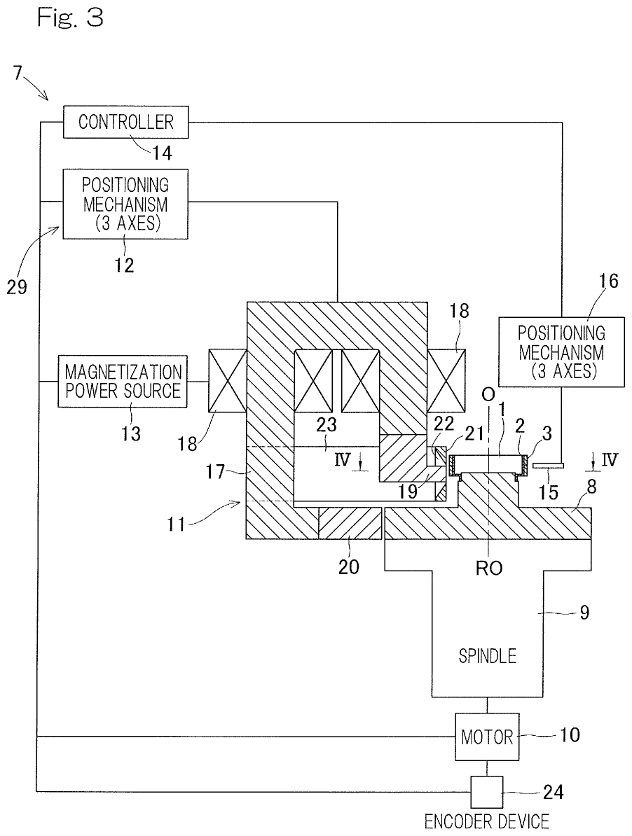

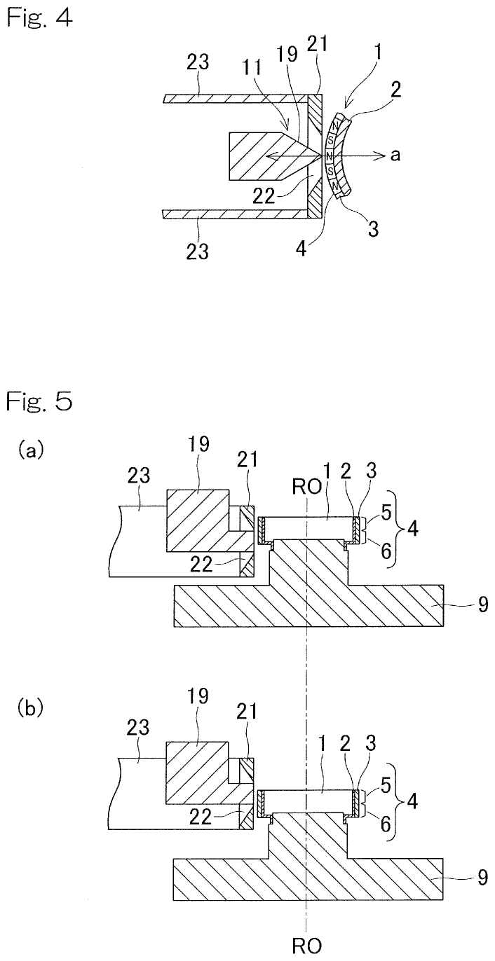

FIG. 3 shows a magnetization device. FIG. 4 is a cross-sectional view taken along a line IV-IV in FIG. 3. The magnetization device 7 of the magnetic encoder includes: a spindle 9 configured to cause a chuck 8 that holds an un-magnetized magnetic encoder 1 as a magnetization target to rotate, with the center-of-annulus O coinciding with the rotation axis RO; a motor 10 configured to rotate the spindle 9; a magnetizing yoke 11; a positioning mechanism 12 configured to position the magnetizing yoke 11 in three axial directions; a magnetization power source 13; and a controller 14. The motor 10 has a highly accurate encoder 24 which is a detection device for detecting a rotation angle. The magnetization device 7 further includes a magnetic sensor 15 configured to measure magnetization accuracy when magnetization of the magnetic encoder 1 held by the chuck 8 is finished. The magnetic sensor 15 is fixed to a positioning mechanism 16 capable of positioning the magnetic sensor 15 in three axial directions. The motor 10 and the positioning mechanism 12 of the magnetizing yoke 11 form a positioning device 29 configured to position a tip portion 19 of the magnetizing yoke 11 relative to the un-magnetized magnetic encoder 1. The controller 14 is implemented as a computer or the like. The controller 14 controls, through numerical control or the like, the magnetization power source 13, and the positioning mechanism 12 and the motor 10 of the positioning device 29 such that individual magnetic tracks 4 of the un-magnetized magnetic encoder 1 are sequentially magnetized, such that the main track 5 is magnetized after the sub track 6 with this order, and such that N magnetic poles and S magnetic poles are alternately arranged.

The magnetizing yoke 11 has a pair of opposed end portions (also referred to as tip portions) 19 and 20 that are magnetically opposed to each other across a magnetic gap. The magnetizing yoke 11 magnetizes the magnetic tracks 4 of the un-magnetized magnetic encoder 1 disposed at a predetermined position and in a predetermined attitude with respect to the opposed end portions 19 and 20. Specifically, the magnetizing yoke 11 is composed of a U-shaped magnetizing yoke body 17, an exciting coil 18, and a first tip portion 19 and a second tip portion 20 respectively provided at one end and the other end of the magnetizing yoke body 17. The exciting coil 18 is wound around the outer periphery of the magnetizing yoke body 17. The magnetizing yoke 11 causes a magnetic flux a (see FIG. 4), for magnetization, to penetrate the magnetic encoder 1. The first tip portion 19 of the magnetizing yoke 11 has a pointed end. During magnetization, the first tip portion 19 is opposed to the surface of the magnetic encoder 1 (i.e., the magnetic track 4). The second tip portion 20 is opposed to the chuck 8 with a gap therebetween, and a magnetic loop, which extends from the first tip portion 19 to the second tip portion 20 through the magnetic encoder 1 and the chuck 8, is formed. The second tip portion 20 may be omitted.

A magnetic shield member 21 has a rectangular hole 22 that has a tapered vertical cross section along the axis RO, and the first tip portion 19 is disposed with respective gaps above and below the hole 22. The magnetic shield member 21 and the first tip portion 19, each opposing the magnetic encoder 1, are positioned with a predetermined gap, e.g., about 0.1 mm, with respect to the un-magnetized magnetic track 4.

The magnetic shield member 21 is fixed to an end portion of a support base 23 that is fixed at a position close to the second tip portion 20 of the magnetizing yoke body 17. Of magnetic fluxes generated from the first tip portion 19, a magnetic flux that affects the other magnetic track 4 not to be magnetized is guided to the magnetic shield member 21 so as to be alleviated toward the second tip portion 20 on the opposite side from the first tip portion 19 that opposes the magnetic encoder 1. The magnetic shield member 21 and the support base 23 are formed of a magnetic body, e.g., a low-carbon steel material. In magnetizing the magnetic encoder 1 having the plurality of rows of magnetic tracks, the magnetic shield member 21 can be opposed to the magnetic track 4 so as to shield the flow of the magnetic flux to the magnetic track other than the magnetization target.

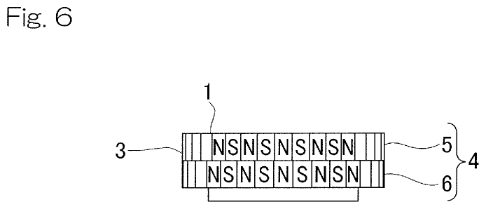

FIG. 5 shows the position where the first tip portion 19 of the magnetizing yoke 11 is disposed when the two rows of magnetic tracks 4 (5 and 6) are magnetized to the magnetic member 3 of the un-magnetized magnetic encoder 1. FIG. 6 shows an example of a magnetization pattern of the magnetic encoder 1 magnetized in the two rows.

Specifically, chart (a) of FIG. 5 shows arrangement of the first tip portion 19 of the magnetizing yoke 11 and the magnetic shield member 21 in a case where the lower half of the magnetic member 3 of the magnetic encoder 1 is magnetized as the magnetic track 4 to be the sub track 6. In this case, the surface of the magnetic member 3, on which the other magnetic track 4 (main track 5) is to be formed, is covered with the magnetic shield member 21 to prevent the magnetic flux, which flows from the first tip portion 19, from flowing to the other magnetic track 4 (main track 5).

Meanwhile, chart (b) of FIG. 5 shows arrangement of the first tip portion 19 of the magnetizing yoke 11 and the magnetic shield member 21 in a case where the upper half of the magnetic member 3 of the magnetic encoder 1 is magnetized as the magnetic track 4 to be the main track 5. At this time, the surface of the magnetic member 3, on which the magnetic track 4 as the sub track 6 magnetized first has been formed, is covered with the magnetic shield member 21 to prevent the magnetic flux, which flows from the first tip portion 19, from flowing to the magnetic track 4 (sub track 6).

When magnetization is performed in an order such that the sub track 6 (magnetic track 4) is formed in the process shown in chart (a) of FIG. 5 and the main track 5 (magnetic track 4) is formed last in the process shown in chart (b) of FIG. 5, degradation in accuracy of the main track 5 is inhibited, whereby an absolute angle can be detected with high accuracy.

According to the present embodiment, as described above, in magnetizing the plurality of rows of magnetic tracks 4, the main track 5 as the magnetic track 4 for calculating an angle is magnetized last. Thus, the magnetic encoder 1, in which degradation in accuracy of the magnetization pitch or the like of the main track 5 is inhibited, can be obtained, and the magnetic encoder 1 can detect an absolute angle with high accuracy.

In the above-described embodiment, the present invention is applied to the radial type magnetic encoder 1. However, the present invention is also applicable to an axial type magnetic encoder and a linear type magnetic encoder.

Although the present invention has been fully described in connection with the preferred embodiments thereof with reference to the accompanying drawings, numerous additions, changes, or deletions can be made without departing from the gist of the present invention. Therefore, such additions, changes, and deletions are also construed as included within the scope of the present invention.

### Reference Numerals

1 . . . magnetic encoder

2 . . . core member

3 . . . magnetic member

4 . . . magnetic track

5 . . . main track

6 . . . sub track

7 . . . magnetization device of magnetic encoder

8 . . . chuck

10 . . . motor

11 . . . magnetizing yoke

12 . . . positioning mechanism

13 . . . magnetization power source

14 . . . controller

19 . . . tip portion

21 . . . shield member

29 . . . positioning device

What is claimed is:

1. A magnetic encoder comprising:
a plurality of rows of magnetic tracks disposed adjacent to each other, each track having N poles and S poles arranged alternately, the plurality of rows of magnetic tracks including a main track used for calculating an angle and a sub track used for calculating a phase difference from the main track, the number of magnetic poles of the main track being larger than the number of magnetic poles of the sub track, wherein
accuracy of pitch of the magnetic poles is higher in the main track than in the sub track.

2. The magnetic encoder as claimed in claim 1, wherein the number of magnetic poles of the main track is larger by one than the number of magnetic poles of the sub track.

3. The magnetic encoder as claimed in claim 1, wherein the plurality of rows of magnetic tracks are annularly arrayed.

4. A method for producing a magnetic encoder comprising a plurality of rows of magnetic tracks disposed adjacent to each other, each track having N poles and S poles arranged alternately, the plurality of rows of magnetic tracks including a main track used for calculating an angle and a sub track used for calculating a phase difference from the main track, the number of magnetic poles of the main track being larger than the number of magnetic poles of the sub track,
the method comprising:
producing the magnetic encoder that has not been magnetized; and
individually magnetizing the respective magnetic tracks of such un-magnetized magnetic encoder in a sequential order such that the main track is magnetized after the sub track, whereby accuracy of pitch of the magnetic poles is made higher in the main track than in the sub track.

5. The method for producing a magnetic encoder as claimed in claim 4, wherein
when magnetization of the respective magnetic tracks is performed, the N poles and the S poles are alternately magnetized one by one while shielding, with a magnetic shield, a portion corresponding to a magnetic track that is not currently being magnetized.

6. An apparatus for producing a magnetic encoder comprising a plurality of rows of magnetic tracks disposed adjacent to each other, each track having N poles and S poles arranged alternately, the plurality of rows of magnetic tracks including a main track used for calculating an angle and a sub track used for calculating a phase difference from the main track, the number of magnetic poles of the main track being larger than the number of magnetic poles of the sub track,
the apparatus comprising:
a magnetizing yoke configured to magnetize the magnetic tracks of the magnetic encoder that has not been magnetized, the magnetizing yoke having end portions opposing the magnetic tracks;
an exciting coil that is wound around the magnetizing yoke;
a magnetization power source configured to supply a magnetization current to the exciting coil to cause a magnetic flux to pass between the opposing end portions;
a positioning device configured to position the magnetizing yoke relative to such un-magnetized magnetic encoder; and
a controller configured to control the magnetization power source and the positioning device, wherein
the controller controls the magnetization power source and the positioning device so as to individually magnetize the respective magnetic tracks of the un-magnetized magnetic encoder in a sequential order such that the main track is magnetized after the sub track, whereby accuracy of pitch of the magnetic poles is made higher in the main track than in the sub track.
